(19) United States
(12) Patent Application Publication
(10) Pub. No.: US 2026/0171593 A1
(43) Pub. Date: Jun. 18, 2026

(54) Cap Plate Coupled to Battery Can and Battery Cell Including the Same

(71) Applicant: LG Energy Solution, Ltd., Seoul (KR)

(72) Inventors: Da-Som Lee, Daejeon (KR); Geon-Woo Min, Daejeon (KR); Kwang-Su Hwangbo, Daejeon (KR); Jae-Min Han, Daejeon (KR); Ji-Yeon Yun, Daejeon (KR)

(73) Assignee: LG Energy Solution, Ltd., Seoul (KR)

(21) Appl. No.: 19/415,278

(22) Filed: Dec. 10, 2025

(30) Foreign Application Priority Data
Dec. 12, 2024 (KR) 10-2024-0184960

(51) Int. Cl. H01M 50/342; H01M 50/136; H01M 50/152; H01M 50/167; H01M 50/186; H01M 50/249

(52) U.S. Cl. CPC H01M 50/3425; H01M 50/136; H01M 50/152; H01M 50/167; H01M 50/186; H01M 50/249

(57) ABSTRACT

A cap plate coupled to a battery can include: a main body that seals the battery can; a vent notch that is formed in the main body, and ruptures when a pressure inside the battery can exceeds a threshold value; and a rupture inducing portion that is formed in the main body while being spaced apart from the vent notch, and induces an occurrence of rupture of the vent notch at a predetermined location.

### CROSS REFERENCE TO RELATED APPLICATIONS

This application is based on and claims priority from Korean Patent Application No. 10-2024-0184960, filed on Dec. 12, 2024, with the Korean Intellectual Property Office, the disclosure of which is incorporated herein in its entirety by reference.

### TECHNICAL FIELD

The present disclosure relates to a cap plate coupled to a battery can, a battery cell including the cap plate, and a battery pack and a vehicle that include the battery cell.

### BACKGROUND

Secondary batteries, which are readily applicable to various product types and have a high energy density as electrical characteristics, are widely used not only in portable devices but also in electric vehicles (EV) and hybrid electric vehicles (HEV) that are powered by electric power sources.

Secondary batteries offer the primary advantage of significantly reducing fossil fuel consumption, and furthermore, generate no by-products during the use of energy. Thus, secondary batteries are gaining attention as a new energy source for enhancing environmental sustainability and energy efficiency.

Presently, widely used types of secondary batteries include lithium-ion batteries, lithium-polymer batteries, nickel-cadmium batteries, nickel-hydrogen batteries, nickel-zinc batteries, and so on. These unit secondary cells have the operating voltage of about 2.5 V to 4.5 V.

Thus, when a higher output voltage is required, a plurality of battery cells is connected in series to form a battery module or a battery pack. Further, according to a required charge and discharge capacity, a plurality of battery cells may be connected in parallel to form a battery module or a battery pack. Therefore, the number of battery cells included in a battery module or a battery pack and the type of electrical connection thereof may be variously set according to at least one of the required output voltage and the required charge and discharge capacity.

### SUMMARY

The present disclosure provides a cap plate coupled to a battery can and having a structure in which a vent notch portion may easily rupture by a rupture inducing portion even when the vent notch portion is formed to have a greater thickness than a specific level, and a battery cell including the cap plate.

Further, the present disclosure provides a cap plate having a structure that enables specification of locations in the vent notch portion where rupture and venting may occur, and a battery cell including the cap plate.

Further, the present disclosure provides a cap plate that may improve mass productivity and facilitate management, and a battery cell including the cap plate.

Further, the present disclosure provides a battery pack and a vehicle that include the battery cell described above.

The objects sought to be achieved by the present disclosure are not limited to those described above, and other objects that are not described herein may clearly be understood by those skilled in the art from the descriptions of the invention herein below.

An aspect of the present disclosure provides a cap plate that is coupled to a battery can. The cap plate includes: a main body that seals the battery can; a vent notch that is formed in the main body, and ruptures when a pressure inside the battery can exceeds a threshold value; and a rupture inducing portion that is formed in the main body while being spaced apart from the vent notch, and induces an occurrence of rupture of the vent notch at a predetermined location.

In an embodiment, at least one rigidity enhancement portion may be formed in the main body, and the at least one rigidity enhancement portion may be configured as a recessed groove formed in a concave shape in the main body at an inner side of the vent notch.

In an embodiment, a plurality of rigidity enhancement portions may be formed in the main body, and the rupture inducing portion may be formed between the plurality of rigidity enhancement portions.

In an embodiment, three rigidity enhancement portions may be formed, and one rupture inducing portion may be formed between two of the three rigidity enhancement portions.

In an embodiment, three rupture inducing portions may be formed, and a central region may be formed at a portion where the three rupture inducing portions intersect, to be linearly connected to each of the three rupture inducing portions.

In an embodiment, the three rupture inducing portions may be spaced apart from each other at an angle of about 120°.

In an embodiment, the recessed groove may include: a first portion formed at the inner side of the vent notch; a second portion extending from one side of the first portion toward an inner side of the main body; a third portion extending from an opposite side of the first portion toward the inner side of the main body; and a fourth portion connecting the second portion and the third portion.

In an embodiment, the vent notch may include a curve, and the first portion may include a curve parallel to a part of the curve of the vent notch.

In an embodiment, the second portion and the third portion may be formed in a linear shape.

In an embodiment, a virtual extension line of the second portion and a virtual extension line of the third portion may be formed to intersect each other.

In an embodiment, the fourth portion may include a curve parallel to a part of the curve of the first portion.

According to another aspect of the present disclosure, a battery cell includes: an electrode assembly including a positive electrode plate, a negative electrode plate, and a separator interposed between the positive electrode plate and the negative electrode plate; a battery can that accommodates the electrode assembly therein, and includes an opened portion and a closed portion; and the cap plate according to claim 1 that seals the opened portion of the battery can.

In an embodiment, the battery cell may further include: a sealing gasket interposed between an edge of the cap plate and the opened portion of the battery can, and the battery can may include: a beading portion formed by pressing an outer peripheral surface of the battery can inward; and a crimping portion extending and bent toward an inner side of the battery can such that the crimping portion and the sealing gasket together enclose and secure the edge of the cap plate.

Yet another aspect of the present disclosure may provide a battery pack including at least one battery cell described above, and a vehicle including at least one battery pack described above.

According to embodiments of the present disclosure, even when the vent notch portion is formed to have a greater thickness than a specific level, the vent notch portion may easily rupture by the rupture inducing portion.

Further, it is possible to specify locations in the vent notch portion where rupture and venting may occur.

Further, the mass productivity may be improved, and the management may be facilitated.

The effects that may be achieved by the present disclosure are not limited to those described above, and other technical effects that are not described herein will be clearly understood by those skilled in the art from the descriptions of the invention herein below.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a perspective view of a conventional cap plate.

FIG. 2 is a perspective view of a cap plate according to an embodiment of the present disclosure.

FIG. 3 is a perspective view illustrating a cross section taken along line A-A′ of FIG. 2.

FIG. 4 is a sectional view when viewed along the line A-A′ of FIG. 2.

FIG. 5 is a perspective view illustrating a cross section taken along line B-B′ of FIG. 2.

FIG. 6 is a sectional view when viewed along the line B-B′ of FIG. 2.

FIG. 7 is a sectional view illustrating a state where the cap plate according to each embodiment of the present disclosure is coupled to a battery cell according to an embodiment of the present disclosure.

FIG. 8 is a view illustrating a battery can in a battery cell according to an embodiment of the present disclosure.

FIG. 9 is a graph illustrating the correlation of the venting pressure of a cap plate according to an embodiment of the present disclosure with the thickness of a vent notch portion in the cap plate.

FIG. 10 is a graph illustrating the correlation of the venting pressure of a battery cell including the cap plate according to an embodiment of the present disclosure, with the thickness of a vent notch portion in the battery cell.

FIG. 11 is a graph illustrating a change of the central portion of the cap plate when the venting pressure is applied to the cap plate according to an embodiment of the present disclosure.

FIG. 12 is a graph illustrating a change in outer diameter of the cap plate when the venting pressure is applied to the cap plate according to an embodiment of the present disclosure.

FIG. 13 is a view schematically illustrating the configuration of a battery pack including a battery cell according to each embodiment of the present disclosure.

FIG. 14 is a view illustrating a vehicle including the battery pack of FIG. 13.

In some of the accompanying drawings, corresponding components will be denoted with the same reference numerals. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to the accompanying drawings. Words and terms used in the detailed description and the claims herein should not be interpreted to be limited to their usual or dictionary meanings, but should be interpreted to have meanings and concepts that correspond to the technical idea of the present disclosure in compliance with the principle that inventors may appropriately define terms and concepts for the purpose of best describing the present disclosure. Accordingly, it can be appreciated that the embodiments described herein and the configurations illustrated in the drawings are merely the most preferable embodiments of the present disclosure, which do not exhaustively represent the technical idea of the present disclosure, and various equivalents and modifications may be made to substitute the present disclosure at the time of filing the present disclosure.

In the drawings, each component or a specific part thereof is exaggerated, omitted, or schematically illustrated for the sake of convenience and clarity in description. Thus, the size of each component may not precisely reflect the actual size thereof. Detailed description of related known functions or configurations may be omitted if determined to obscure the gist of the present disclosure.

As used herein, the terms “coupled” and “connected” indicate not only a case where a member is directly coupled or connected to another member, but also a case where a member is indirectly coupled or connected to another member via a connection member.

As used herein, the terms “about,” “approximately,” and “substantially” refer to a range of, or approximation to a numerical value or degree, taking into account inherent manufacturing and material tolerances (e.g., ±5 %).

As types of secondary battery cells, cylindrical, prismatic, and pouch-type battery cells are known. In the case of cylindrical battery cells, a separator serving as an insulator is interposed between a positive electrode plate and a negative electrode plate, and is wound together to form a jelly-roll type electrode assembly. Then, the electrode assembly is inserted into a battery can together with an electrolyte to manufacture a battery.

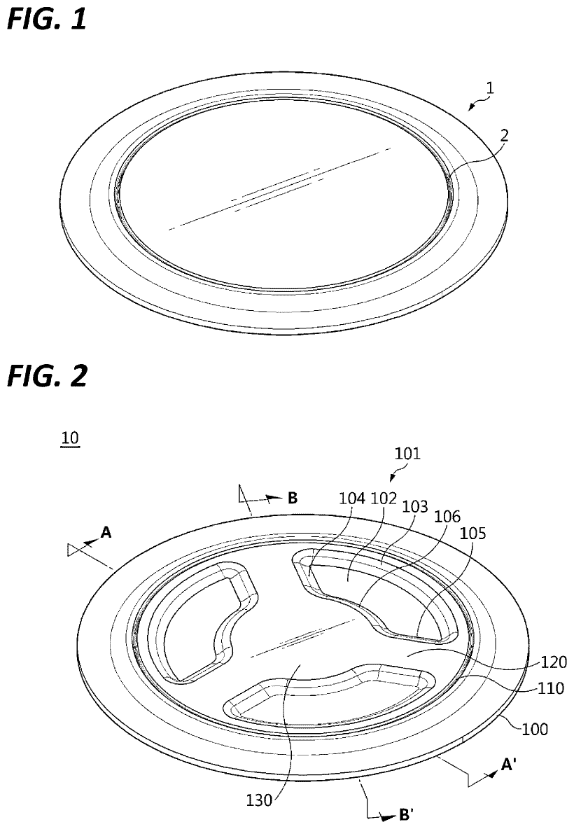

FIG. 1 is a perspective view of a conventional cap plate that is coupled to a battery can. A cap plate 1 is coupled to a battery can of, for example, a cylindrical battery cell.

Referring to FIG. 1, a vent notch portion 2 is formed in the cap plate 1, and is configured to rupture when the pressure inside the battery can exceeds a threshold value. FIG. 1 omits the illustration of the battery can, and illustrates only the cap plate 1.

As the thickness of the vent notch portion 2 of the cap plate 1 is thin, the vent notch portion 2 may easily rupture upon an occurrence of a thermal event. However, there is a limit to make the vent notch portion 2 thin through a processing.

Further, when the thickness of the vent notch portion 2 decreases to a specific level or less, there may be a problem in that leakage of an electrolyte, a gas, or the like may occur due to cracks during the activation process of the battery cell.

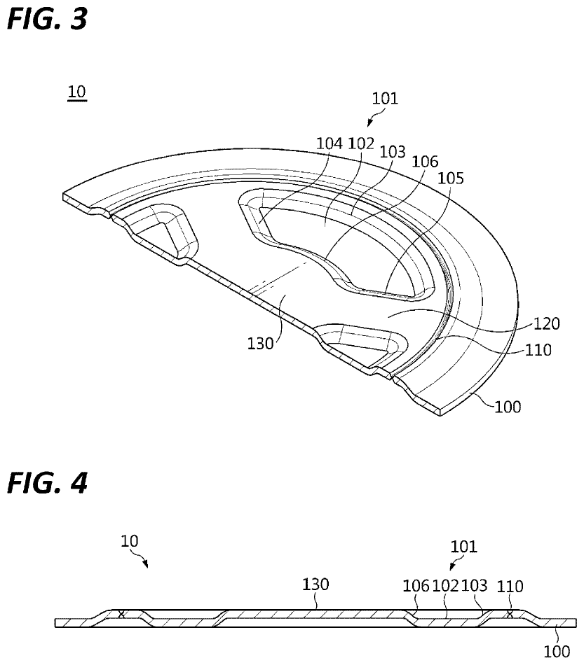

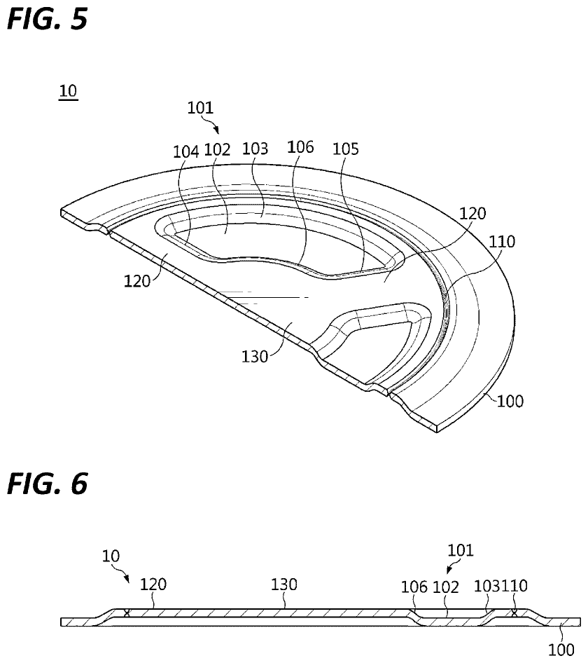

FIG. 2 is a perspective view of a cap plate 10 according to an embodiment of the present disclosure, FIG. 3 is a perspective view illustrating a cross section of the cap plate 10 taken along line A-A′ of FIG. 2, FIG. 4 is a sectional view of the cap plate 10 when viewed along the line A-A′ of FIG. 2, FIG. 5 is a perspective view illustrating a cross section of the cap plate 10 taken along line B-B′ of FIG. 2, and FIG. 6 is a sectional view when viewed along the line B-B′ of FIG. 2.

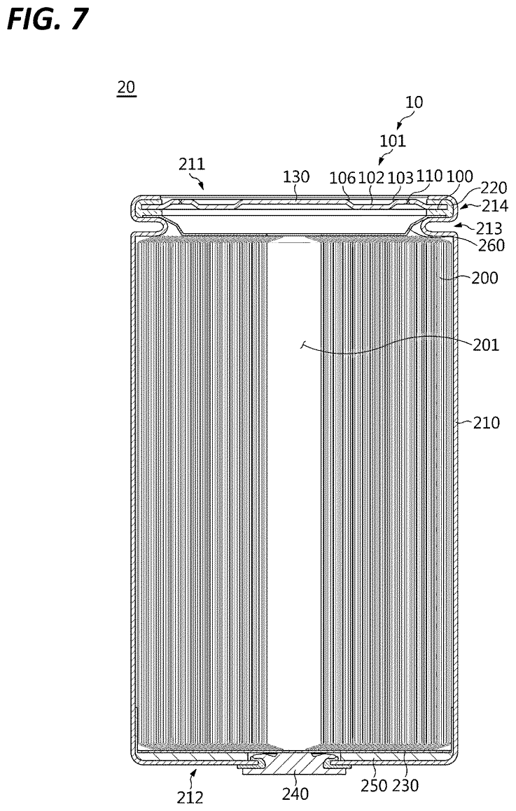

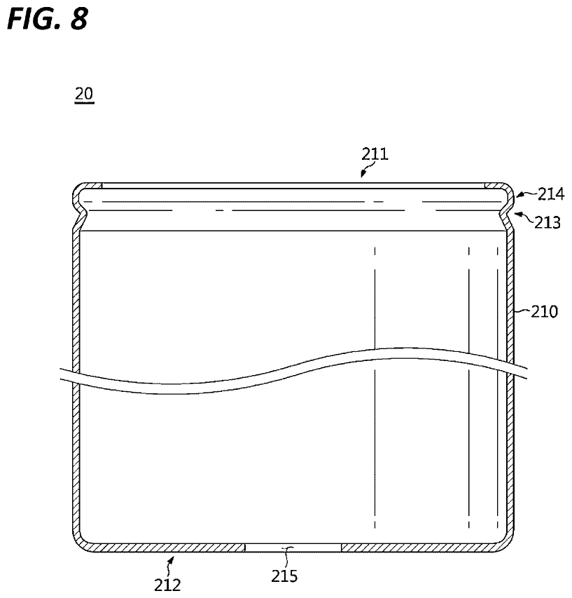

Referring to FIG. 2, the cap plate 10 according to an embodiment of the present disclosure is coupled to a battery can 210 of a battery cell 20, which will be described herein later with reference to, for example, FIGS. 7 and 8, and includes a main body 100, a vent notch portion 110, and a rupture inducing portion 120.

The main body 100 is coupled to the battery can 210 of the battery cell 20, and seals the battery can 210. Referring to FIGS. 7 and 8, when the battery can 210 of the battery cell 20 includes an opened portion 211 and a closed portion 212, the main body 100 is configured to seal the opened portion 211 of the battery can 210.

A sealing gasket 220 may be coupled to the edge of the main body 100 to ensure the airtightness of the battery can 210.

The vent notch portion 110 is formed in the main body 100 to rupture upon an occurrence of a thermal event, thereby discharging a gas inside the battery can 210. Here, the vent notch portion 110 is formed as a region having a thin thickness than the peripheral region of the main body 100, and is configured to rupture when the pressure inside the battery can 210 exceeds a threshold value.

Since the thickness of the vent notch portion 110 is thinner than the peripheral region, the vent notch portion 110 may rupture more easily, and when the pressure inside the battery can 210 increases to a specific level or higher, the vent notch portion 110 ruptures, and a gas generated inside the battery can 210 may be discharged. For example, the vent notch portion 110 may be formed by a notching.

The vent notch portion 110 may have various shapes. For example, the vent notch portion may be formed in at least one pattern of a continuous circular pattern, a discontinuous circular pattern, and a linear pattern in the surface of the cap plate 10. Further, the vent notch portion may be formed in other various patterns.

According to an embodiment, the vent notch portion 110 may be formed in various shapes including curves, and for example, may be formed in a circular shape as in FIG. 2, but the shape of the vent notch portion 110 is not limited thereto. For the convenience in description, hereinafter, descriptions will be made assuming a case where the vent notch portion 110 is formed in a circular shape.

The rupture inducing portion 120 is formed in the main body 100 to be spaced apart from the vent notch portion 110. The rupture inducing portion 120 may be formed at various positions, and for example, may be formed at the inner side of the vent notch portion 110, but is not limited thereto. For the convenience in description, hereinafter, descriptions will be made assuming a case where the rupture inducing portion 120 is formed at the inner side of the vent notch portion 110.

Here, the inner side and the outer side are defined based on the radial direction of the cap plate 10. For example, in the radial direction, the side where the diameter increases from the center of the cap plate 10 will be referred to as the outer side, and the side where the diameter decreases therefrom will be referred to as the inner side.

The rupture inducing portion 120 is formed in the main body 100 such that the vent notch portion 110 may easily rupture at predetermined locations.

In the case where the vent notch portion 2 is formed in the circular shape having a uniform thickness as in the conventional cap plate 1 of FIG. 1, there is a problem in that when the pressure inside the battery can increases upon an occurrence of a thermal event, it is difficult to predict which part in the vent notch portion 2 will rupture. For example, since an arbitrary part in the vent notch portion ruptures, it is difficult to accurately predict the rupturing part, which may deteriorate the gas venting efficiency.

In the cap plate 10 according to an embodiment of the present disclosure, the rupture inducing portion 120 is formed. Thus, when the pressure inside the battery can 210 increases, the vent notch portion 110 may easily rupture at the location where the rupture inducing portion 120 is formed. Therefore, the cap plate 10 may be designed such that the vent notch portion 110 ruptures at a predetermined location.

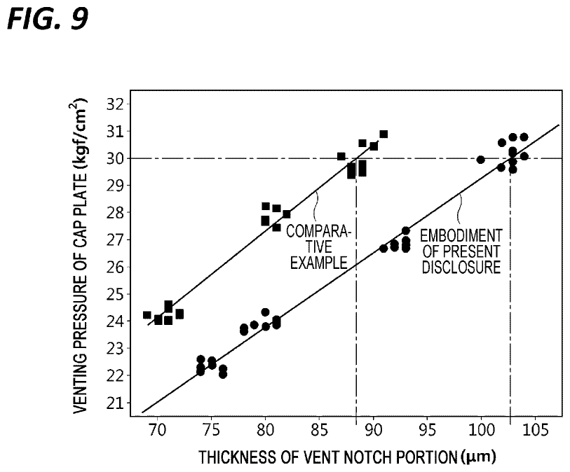

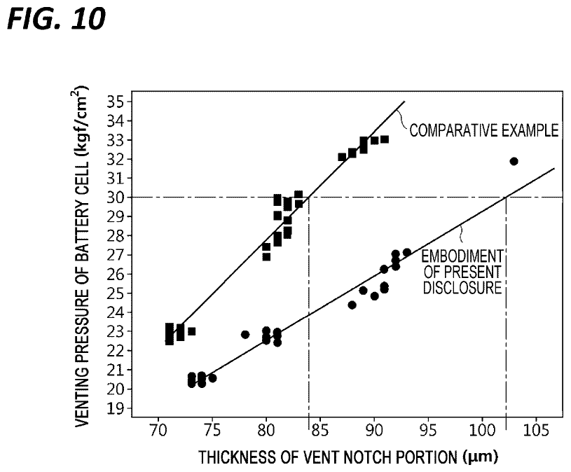

Further, referring to FIGS. 9 and 10 to be described herein later, the vent notch portion 110 may be formed in the cap plate 10 to have a greater thickness with respect to the same venting pressure, in order to prevent or suppress cracking of the cap plate 10.

Referring to FIGS. 2 to 4, at least one rigidity reinforcement portion 101 may be formed in the main body 100. The rigidity reinforcement portion 101 may be formed in various shapes, and for example, may be configured as a recessed groove 102 formed in a concave shape in the main body 100 at the inner side of the vent notch portion 110.

When the recessed groove 102 is formed in the main body 100, rigidity against bending (bending rigidity) increases in the region of the recessed groove 102.

When the recessed groove 102 is formed in the main body 100, the second moment of area varies due to the change in shape of the cross-section. For example, when the recessed groove 102 is formed, the material is redistributed to regions farther from the neutral axis, and as a result, the second moment of area increases. Since the bending rigidity is proportional to the second moment of area, both the second moment of area and the bending rigidity increase when the recessed groove 102 is formed in the main body 100.

The portion of the main body 100 where the recessed groove 102 is formed has the enhanced bending rigidity, as compared to the portion thereof where the recessed groove 102 is not formed, and therefore, may function as the rigidity reinforcement portion 101.

Referring to FIGS. 2, 3, and 5, the recessed groove 102 may include a first portion 103, a second portion 104, a third portion 105, and a fourth portion 106.

The first portion 103 is formed at the inner side of the vent notch portion 110. The first portion 103 may be formed in various shapes. For example, as described above, when the vent notch portion 110 is formed in a circular shape among various shapes including curves, the first portion 103 may include a curve parallel to a part of the curve of the vent notch portion 110. However, the shape of the first portion 103 is not limited thereto.

The description that a part of the curve of the vent notch portion 110 and the curve of the first portion 103 are parallel to each other indicates that both a part of the vent notch portion 110 and the first portion 103 are curved but do not intersect each other. This configuration is merely an example, and a part of the curve of the vent notch portion 110 and the curve of the first portion 103 may not necessarily be parallel to each other.

The second portion 104 extends from one side of the first portion 103 toward the inner side of the main body 100. Here, the second portion 104 may be formed in a linear shape.

The third portion 105 extends from the opposite side of the first portion 103 toward the inner side of the main body 100. The third portion 105 may be formed in a linear shape.

The second portion 104 and the third portion 105 may be formed such that virtual extension lines thereof intersect each other. For example, this configuration indicates that the second portion 104 and the third portion 105 are not parallel to each other.

The fourth portion 106 is configured to connect the second portion 104 and the third portion 105. The fourth portion 106 may have various shapes, and for example, may include a curve parallel to a part of the curve of the first portion 103, but is not limited thereto.

Referring to FIG. 2, the rupture inducing portion 120 may be formed between a plurality of rigidity reinforcement portions 101, for example, between a plurality of recessed grooves 102. The rupture inducing portion 120 itself does not rupture, but induces an occurrence of rupture in the vent notch portion 110 located near the portion where the rupture inducing portion 120 is formed.

As described above, when the recessed groove 102 is formed in the main body 100, the bending rigidity increases in the recessed groove 102, as compared to in the rupture inducing portion 120 where the recessed groove 102 is not formed. Therefore, the vent notch portion 110 located near the portion where the recessed groove 102 is formed is relatively unlikely to rupture.

For example, even when the entire vent notch portion 110 has the uniform thickness, and the same pressure is applied to the vent notch portion 110, rupture hardly occurs in the vent notch portion 110 located adjacent to the recessed groove 102 that has the enhanced bending rigidity and therefore does not easily deform, and the rupture relatively easily occurs in the vent notch portion 110 located adjacent to the rupture inducing portion 120 formed between recessed grooves 102.

As a result, even when the vent notch portion 110 is formed to have a greater thickness than a specific level, the vent notch portion 110 may easily rupture by the rupture inducing portion 120.

The rupture inducing portion 120 induces an occurrence of rupture in the vent notch portion 110 located adjacent thereto, and as a result, it is possible to specify locations in the vent notch portion 110 where venting may occur.

When venting locations in the vent notch portion 110 are specified, a gas or the like may be vented in specific directions, which is advantageous in designing the battery cell 20, improves mass productivity, and facilitates management.

Referring to FIG. 2, according to an embodiment, three recessed grooves 102 may be formed. However, the number of recessed grooves 102 may vary, and the case where three recessed grooves 102 are formed is merely an example. For the convenience in description, hereinafter, descriptions will be made assuming the case where three recessed grooves 102 are formed.

According to an embodiment, one rupture inducing portion 120 may be formed between two of the three recessed grooves 102.

Referring to FIG. 2, according to an embodiment, a central portion 130 may be formed at the portion where the three rupture inducing portions 120 intersect. Referring to FIGS. 5 and 6 as well, each rupture inducing portion 120 and the central portion 130 may be connected with a straight line. For example, the rupture inducing portion 120 and the central portion 130 are positioned on the same straight line, and the recessed groove 102 is formed to be recessed below the rupture inducing portion 120 and the central portion 130. Here, the recessed groove 102 may be formed by, for example, a press processing.

Referring back to FIG. 2, the three rupture inducing portions 120 may be spaced apart from each other by about 120°. However, the present disclosure is not limited thereto.

Meanwhile, in the embodiment described above, the cap plate 10 is designed such that rupture occurs at specific locations in the vent notch portion 110 according to the positions of the rupture inducing portions 120. However, the present disclosure is not limited thereto, and rupture may occur at other locations in the cap plate 10, rather than the vent notch portion 110. For example, the cap plate 10 may be designed such that rupture occurs at the rupture inducing portion 120, or alternatively, at the recessed groove 102 of the rigidity reinforcement portion 101.

FIG. 7 is a sectional view illustrating a state where the cap plate 10 according to each embodiment of the present disclosure is coupled to the battery cell 20 according to an embodiment of the present disclosure, and FIG. 8 is a view illustrating the battery can 210 of the battery cell according to an embodiment of the present disclosure.

Referring to FIG. 7, the cylindrical battery cell 20 according to an embodiment of the present disclosure includes an electrode assembly 200, the battery can 210, and the cap plate 10.

The electrode assembly 200 includes a positive electrode plate, a negative electrode plate, and a separator interposed between the positive electrode plate and the negative electrode plate, and may have a structure in which the positive electrode plate, the negative electrode plate, and the separator are wound in one direction. A central hole 201 is formed at the center of the electrode assembly 200, and the electrode assembly 200 may be formed in the jelly-roll shape.

For example, the electrode assembly 200 may be manufactured by winding a stacked structure in which the negative electrode plate, the separator, the positive electrode plate, and the separator are stacked in this order at least once. Here, the positive electrode plate and the negative electrode plate may be formed in the sheet shape.

The electrode assembly 200 applied to the present embodiment may be a wound-type electrode assembly 200. In this case, an additional separator may be provided on the outer peripheral surface of the electrode assembly 200 to ensure insulation from the battery can 210. The electrode assembly 200 may have any wound structure well-known in the related art without limitation.

A positive electrode active material is coated on one surface or both surfaces of the positive electrode plate, and a first uncoated portion on which the positive electrode active material is not coated may be formed at the end of the positive electrode plate. The first uncoated portion may be exposed outside the separator by forming a plurality of winding turns around the center of the electrode assembly 200, and thus, may be used as an electrode tab as it is. However, the positive electrode plate may not include the first uncoated portion.

A negative electrode active material is coated on one surface or both surfaces of the negative electrode plate, and a second uncoated portion on which the negative electrode active material is not coated may be formed at the end of the negative electrode plate. The second uncoated portion may be exposed outside the separator by forming a plurality of winding turns around the center of the electrode assembly 200, and thus, may be used as an electrode tab as it is. However, the negative electrode plate may not include the second uncoated portion.

When the positive electrode plate and the negative electrode plate include the uncoated portions, respectively, the first uncoated portion and the second uncoated portion may be configured to face opposite directions.

The positive electrode active material coated on the positive electrode plate and the negative electrode active material coated on the negative electrode plate are not particularly limited, and may be any active materials well-known in the art.

The separator may be manufactured using a porous polymer film formed of a polyolefin-based polymer such as an ethylene homopolymer, a propylene homopolymer, an ethylene/butene copolymer, an ethylene/hexene copolymer, or an ethylene/methacrylate copolymer, either alone or in a laminated form.

As another example, the separator may be manufactured using a conventional porous nonwoven fabric such as a nonwoven fabric formed of, for example, glass fiber with a high melting point or polyethylene terephthalate fiber.

At least one surface of the separator may include a coating layer of inorganic particles. The separator itself may be formed of the coating layer of inorganic particles. The particles of the coating layer may be bound with a binder to form interstitial volumes between adjacent particles.

The central hole 201 of the electrode assembly 200 may also be used for welding a cell terminal 240 (positive electrode terminal) and a positive electrode current collector plate 230. For example, a laser may be irradiated through the central hole 201 of the electrode assembly 200 to weld the cell terminal 240 and the positive electrode current collector plate 230.

The electrode assembly 200 is accommodated in the battery can 210. For example, the battery can 210 may be formed in a cylindrical shape, and the electrode assembly 200 is accommodated in the battery can 210, so that the battery can 210 is electrically connected to the negative electrode plate of the electrode assembly 200. Accordingly, the battery can 210 may have the same polarity as the negative electrode plate, for example, a negative polarity.

Referring to FIG. 8, the battery can 210 may include the closed portion 212 and the opened portion 211 that are positioned to face each other.

For example, as illustrated in FIG. 8, the opened portion 211 may be formed at the top of the battery can 210. The electrode assembly 200 may be accommodated in the battery can 210 through the opened portion 211 formed at the top of the battery can 210, and an electrolyte may also be injected through the opened portion 211 formed at the top of the battery can 210. However, the opened portion 211 may be formed at the bottom of the battery can 210.

The battery can 210 may be a substantially cylindrical container with the opened portion 211 formed at the top thereof, and is made of, for example, a conductive material such as a metal. The material of the battery can 210 may be a conductive metal such as aluminum, steel, or stainless steel, but is not limited thereto. A Ni coating layer may be formed on the surface of the battery can 210.

As illustrated in FIG. 8, the closed portion 212 may be formed at the bottom of the battery can 210. A through hole 215 is formed in the closed portion 212, and the cell terminal 240 may be coupled to the through hole 215 as illustrated in FIG. 7.

The diameter of the battery can 210 is greater than that of the electrode assembly 200. A gap is formed in a predetermined size between the battery can 210 and the positive electrode current collector plate 230, and an insulator 250 may be disposed in the gap.

When the size of the electrode assembly 200 is increased in the state where the size of the battery can 210 is fixed according to specifications, the overall capacity of the battery cell 20 increases, but the gap between the battery can 210 and the electrode assembly 200 is reduced.

When the size of the electrode assembly 200 is increased to enhance the overall capacity of the battery cell 20, the gap between the battery can 210 and the electrode assembly 200 is reduced. Thus, in order to enhance the overall capacity of the battery cell 20, the thickness of the insulator 250 may be as thin as possible such that the insulator 250 may be disposed in the reduced gap between the battery can 210 and the electrode assembly 200.

The battery can 210 may be a substantially cylindrical container, and may be formed of a conductive material such as a metal. The material of the battery can 210 may be a conductive metal such as aluminum, steel, or stainless steel, but is not limited thereto.

The cap plate 10 includes the rupture inducing portion 120 according to each embodiment described above, and has the same configuration as described above.

The cap plate 10 is coupled to the battery can 210, and is configured to seal the opened portion 211 formed in the battery can 210. The cap plate 10 may be made of, for example, a metal material to ensure rigidity.

The cap plate 10 may be provided to be non-polar by being separated from the electrode assembly 200. For example, even when the cap plate 10 is formed of a conductive metal material, the cap plate 10 may have no polarity.

The description that the cap plate 10 has no polarity indicates that the cap plate 10 is electrically insulated from the battery can 210 and the cell terminal 240. In this way, the cap plate 10 may not have polarity, and the material thereof may not necessarily be the conductive metal.

The cap plate 10 may be seated and supported on a beading portion 213 formed in the battery can 210. Further, the cap plate 10 may be secured by a crimping portion 214. A sealing gasket 220 may be interposed between the cap plate 10 and the crimping portion 214 of the battery can 210 to ensure the airtightness of the battery can 210. For example, the sealing gasket 220 may be disposed between the edge of the cap plate 10 and the opened portion 211 of the battery can 210.

In the cap plate 10, the vent notch portion 110 may be formed to rupture due to the pressure inside the battery can 210 as described above.

In the battery can 210, the beading portion 213 and the crimping portion 214 may be formed.

The beading portion 213 is formed by pressing the outer peripheral surface of the battery can 210 inward. The beading portion 213 supports the electrode assembly 200 having the size substantially corresponding to the width of the battery can 210 to prevent the electrode assembly 200 from being withdrawn from the battery can 210, and may also serve as a support on which the cap plate 10 is seated. Further, the beading portion 213 may support the outer peripheral surface of the sealing gasket 220.

The crimping portion 214 extends and is bent toward the inner side of the battery can 210, such that the crimping portion 214 and the sealing gasket 220 together enclose and secure the edge of the cap plate 10. As illustrated in FIG. 7, the crimping portion 214 may be formed above the beading portion 213 in view of FIG. 7. This configuration is merely an example, and the positions of the crimping portion 214 and the beading portion 213 are not limited thereto.

In the case where the crimping portion 214 is formed above the beading portion 213 in view of FIG. 7, the crimping portion 214 has the shape extending and bent to enclose the peripheral edge of the cap plate 10 disposed on the upper side of the beading portion 213. With the bent shape of the crimping portion 214, the cap plate 10 may be fixed on the beading portion 213.

The positive electrode current collector plate 230 is electrically connected to the positive electrode plate of the electrode assembly 200. For example, the positive electrode current collector plate 230 may be made of a conductive metal material, and electrically connected to the first uncoated portion of the positive electrode plate.

The cell terminal 240 is made of a conductive metal material, and is electrically connected to the positive electrode current collector plate 230. The cell terminal 240 is electrically connected to the positive electrode plate of the electrode assembly 200 via the positive electrode current collector plate 230, and thus, has a positive polarity.

According to an embodiment, the cell terminal 240 may function as a positive electrode terminal. Meanwhile, the battery can 210 is electrically connected to the negative electrode plate of the electrode assembly 200 as described above, and thus, may have a negative polarity.

A negative electrode current collector plate 260 is electrically connected to the negative electrode plate of the electrode assembly 200. For example, the negative electrode current collector plate 260 may be made of a conductive metal material such as aluminum, steel, copper, or nickel, and may be electrically connected to the second uncoated portion of the negative electrode plate.

At least a part of the edge of the negative electrode current collector plate 260 may be interposed and secured between the inner surface of the battery can 210 and the sealing gasket 220.

FIG. 9 is a graph illustrating the correlation of the venting pressure with the thickness of the vent notch portion 110 in the cap plate 10 according to an embodiment of the present disclosure, and FIG. 10 is a graph illustrating the correlation of the venting pressure with the thickness of the vent notch portion 110 in the battery cell 20 including the cap plate 10 according to an embodiment of the present disclosure.

FIG. 9 is a graph obtained by measuring the venting pressure of the cap plate 10 alone in which the vent notch portion 110 is formed. Here, the comparative example indicates the conventional cap plate 1 illustrated in FIG. 1, and the embodiment of the present disclosure indicates the cap plate 10 of FIG. 2 according to an embodiment of the present disclosure.

FIG. 10 is a graph obtained by measuring the venting pressure of the battery cell 20 in which the cap plate 10 with the vent notch portion 110 is coupled to the battery can 210. Here, the comparative example indicates the battery cell to which the conventional cap plate 1 of FIG. 1 is coupled, and the embodiment of the present disclosure indicates the battery cell 20 to which the cap plate 10 of FIG. 2 according to an embodiment of the present disclosure is coupled.

FIG. 9 illustrates the graph for changes in venting pressure according to the thickness of the vent notch portion in the cap plate 1 of FIG. 1 and the thickness of the vent notch portion 110 in the cap plate 10 of FIG. 2, and FIG. 10 illustrates the graph for changes in venting pressure according to the thickness of the vent notch portion of the cap plate 1 in the battery cell to which the cap plate 1 of FIG. 1 is coupled, and the thickness of the vent notch portion 110 of the cap plate 10 in the battery cell 20 to which the cap plate 10 of FIG. 2 is coupled.

Referring to FIGS. 9 and 10 together, it may be seen that when the same venting pressure is applied, the thickness of the vent notch portion 110 of the embodiment of the present disclosure is greater than the thickness of the vent notch portion of the comparative example.

For example, in FIG. 9, when the venting pressure is 30 kgf/cm², the thickness of the vent notch portion of the comparative example is about 87.5 μm, whereas the thickness of the vent notch portion 110 of the embodiment of the present disclosure is about 102 μm. For example, in FIG. 10, when the venting pressure is 30 kgf/cm², the thickness of the vent notch portion of the comparative example is about 84 μm, whereas the thickness of the vent notch portion 110 of the embodiment of the present disclosure is about 102 μm.

As described above, when the thickness of the vent notch portion 110 decreases to a specific level or less, there may be a problem in that leakage of an electrolyte, a gas, or the like may occur due to cracks during the activation process of the battery cell.

However, referring to FIGS. 9 and 10, in the embodiment of the present disclosure, the vent notch portion 110 having a relatively greater thickness under the same venting pressure may be formed in the cap plate 10, so that cracking of the cap plate 10 may be prevented.

Further, since the embodiment of the present disclosure is less sensitive to the thickness of the vent notch portion 110, it is easy to secure variation tolerance in thickness of the vent notch portion 110, and even when the thickness of the vent notch portion 110 is not uniform due to, for example, processing errors, rupture may easily occur at the predetermined locations in the vent notch portion 110.

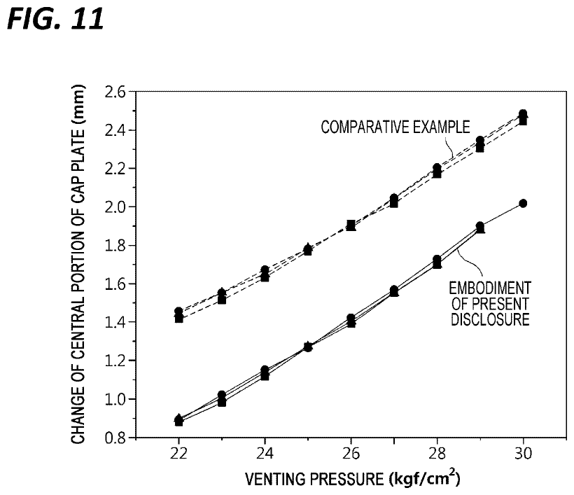

FIG. 11 illustrates the graph for the change of the central portion of the cap plate 10 according to an embodiment of the present disclosure, when the venting pressure is applied to the cap plate 1.

Here, the comparative example indicates the conventional cap plate 1 of FIG. 1, and the embodiment of the present disclosure indicates the cap plate 10 according to an embodiment of the present disclosure.

Referring to FIG. 11, the amount of change in the central portion of the cap plate 10 according to an embodiment of the present disclosure is smaller than that of the central portion of the cap plate 1 of the comparative example when the venting pressure is applied to the cap plate 1 and the cap plate 10.

For example, since the amount of change in the central portion 130 of the cap plate 10 according to an embodiment of the present disclosure is relatively smaller, the deformation of the battery cell 20 in the height direction may be suppressed even when the pressure inside the battery can 210 exceeds the threshold value upon an occurrence of a thermal event.

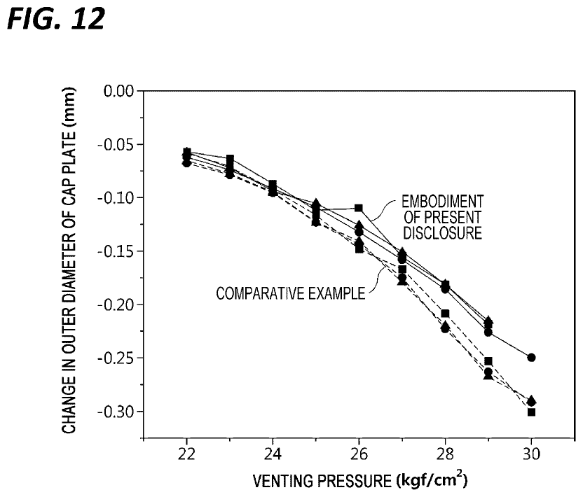

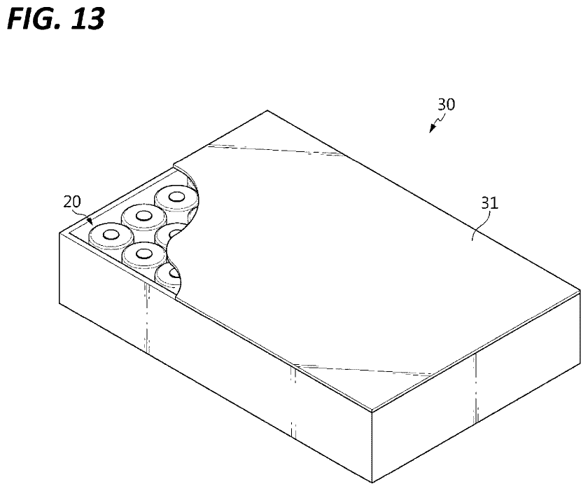

FIG. 12 is a graph illustrating the change in outer diameter of the cap plate 10 when the venting pressure is applied to the cap plate according to an embodiment of the present disclosure (e.g., the amount of change in outer diameter of the cap plate 10 caused from the venting pressure).

In the graph of FIG. 12, the change in outer diameter of the cap plate 10 is represented as a value obtained by subtracting the initial outer diameter from the outer diameter after change. Since the outer diameter of the cap plate 10 decreases when the venting pressure is applied, the amount of change is represented as a negative (minus) value.

Referring to FIG. 12, the amount of change in outer diameter of the cap plate 10 according to an embodiment of the present disclosure is smaller than that of the comparative example.

As described above, when the cap plate 10 is secured by the crimping portion 214, a gap may be formed between the cap plate 10 and the crimping portion 214 in the event that the outer diameter of the cap plate 10 contracts, and as a result, a gas may be discharged through the crimping portion 214, which may deteriorate the safety of the battery cell 20.

Referring to FIG. 12, since the amount of change in outer diameter of the cap plate 10 according to an embodiment of the present disclosure is smaller than that of the cap plate 1 of the comparative example, it is possible to minimize the discharge of a gas through the gap between the cap plate 10 and the crimping portion 214 upon an occurrence of a thermal event in the battery cell 20.

FIG. 13 is a view schematically illustrating the configuration of a battery pack including the battery cell according to each embodiment of the present disclosure.

Referring to FIG. 13, the battery pack 30 according to an embodiment of the present disclosure may include one or more battery cells 20 according to each embodiment of the present disclosure described above. Here, the battery cell 20 according to each embodiment of the present disclosure includes the cap plate 10 according to each embodiment of the present disclosure.

Further, the battery pack 30 may further include a pack case 31 for accommodating the battery cells 20, and various devices for controlling the charging and discharging of the battery cells 20, for example, a BMS (Battery Management System), a current sensor, and a fuse.

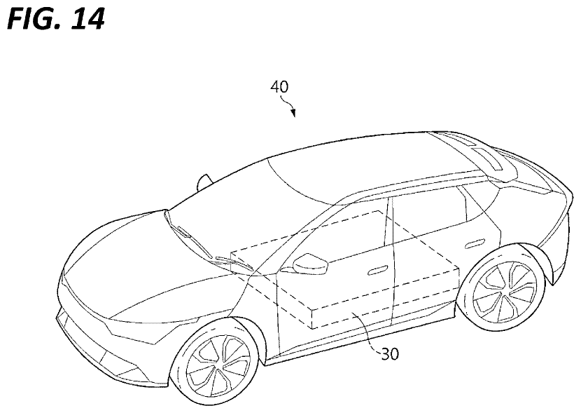

FIG. 14 is a view illustrating a vehicle including the battery pack of FIG. 13.

Referring to FIG. 14, a vehicle 40 according to an embodiment of the present disclosure may include one or more battery cells 20 or battery packs 30 according to each embodiment of the present disclosure described above. Here, the vehicle 40 includes, for example, various types of vehicles using electric power, such as electric vehicles and hybrid vehicles.

In the descriptions herein, terms indicating directions such as “upper,” “lower,” “left,” and “right” are used merely for the convenience in description, and it is appreciated to those skilled in the art that the terms may vary according to, for example, a position of an object or an observer.

While the present disclosure has been described with reference to the limited embodiments and drawings, the present disclosure is not limited thereto, and various modifications and changes may be made by those skilled in the art of the present disclosure within the technical idea of the present disclosure and the scope equivalent to the claims set forth below. Therefore, the foregoing embodiments should be considered from the descriptive viewpoint, rather than from the limiting viewpoint. That is, the essential scope of the technical idea of the present disclosure may be found in the claims attached herewith, and any differences that fall under the equivalent scope to the present disclosure should be construed as being included in the present disclosure.

What is claimed is:

1. A cap plate coupled to a battery can, the cap plate comprising:
a main body configured to seal the battery can;
a vent notch formed in the main body, and configured to rupture when a pressure inside the battery can exceeds a threshold value; and
a rupture inducing portion formed in the main body while being spaced apart from the vent notch, and configured to induce an occurrence of rupture of the vent notch at a predetermined location.

2. The cap plate according to claim 1, wherein at least one rigidity enhancement portion is formed in the main body, and
the at least one rigidity enhancement portion is configured as a recessed groove formed in a concave shape in the main body at an inner side of the vent notch.

3. The cap plate according to claim 2, wherein a plurality of rigidity enhancement portions is formed in the main body, and
the rupture inducing portion is formed between the plurality of rigidity enhancement portions.

4. The cap plate according to claim 3, wherein three rigidity enhancement portions are formed, and
one rupture inducing portion is formed between two of the three rigidity enhancement portions.

5. The cap plate according to claim 4, wherein three rupture inducing portions are formed, and
a central region is formed at a portion where the three rupture inducing portions intersect, to be linearly connected to each of the three rupture inducing portions.

6. The cap plate according to claim 5, wherein the three rupture inducing portions are spaced apart from each other at an angle of about 120°.

7. The cap plate according to claim 2, wherein the recessed groove includes:
a first portion formed at the inner side of the vent notch;
a second portion extending from one side of the first portion toward an inner side of the main body;
a third portion extending from an opposite side of the first portion toward the inner side of the main body; and
a fourth portion connecting the second portion and the third portion.

8. The cap plate according to claim 7, wherein the vent notch includes a curve, and
the first portion includes a curve parallel to a part of the curve of the vent notch.

9. The cap plate according to claim 7, wherein the second portion and the third portion are formed in a linear shape.

10. The cap plate according to claim 9, wherein a virtual extension line of the second portion and a virtual extension line of the third portion are formed to intersect each other.

11. The cap plate according to claim 8, wherein the fourth portion includes a curve parallel to a part of the curve of the first portion.

12. A battery cell comprising:
an electrode assembly including a positive electrode plate, a negative electrode plate, and a separator interposed between the positive electrode plate and the negative electrode plate;
a battery can configured to accommodate the electrode assembly therein, and including an opened portion and a closed portion; and
the cap plate according to claim 1 configured to seal the opened portion of the battery can.

13. The battery cell according to claim 12, further comprising:
a sealing gasket interposed between an edge of the cap plate and the opened portion of the battery can,
wherein the battery can includes:
a beading portion formed by pressing an outer peripheral surface of the battery can inward; and
a crimping portion extending and bent toward an inner side of the battery can such that the crimping portion and the sealing gasket together enclose and secure the edge of the cap plate.

14. A battery pack comprising at least one battery cell according to claim 12.

15. A vehicle comprising at least one battery pack according to claim 14.
